(19) United States
(12) Patent Application Publication
(10) Pub. No.: US 2026/0043696 A1
(43) Pub. Date: Feb. 12, 2026

(54) TACTILE SENSORS

(71) Applicant: Allegro MicroSystems, LLC, Manchester, NH (US)

(72) Inventor: Ronald Lehndorff, Mainz (DE)

(73) Assignee: Allegro MicroSystems, LLC, Manchester, NH (US)

(21) Appl. No.: 18/796,588

(22) Filed: Aug. 7, 2024

(51) Int. Cl. G01L 1/22

(52) U.S. Cl. CPC G01L 1/2287

(57) ABSTRACT

Tactile sensors have conductive traces disposed on a deformable conductive layer that is disposed on electrodes on a substrate. Monitoring circuitry can detect changes in conductivity, resistance, and/or current due to deformation of the deformable layer in response to applied forces and produce corresponding output signals indicative of the deformation of the deformable layer. Magnitude, direction, duration and/or location of the force or pressure causing the deformation can be determined from the output signals. Related methods of manufacturing tactile sensors are described.

### BACKGROUND

Touch sensors typically provide an input mechanism for a device or system through tactile or haptic functionality, such as for example, by touching a sensor surface of the sensor device. Different types of touch sensors may require touch input to be provided by different mechanisms. For example, capacitive touch sensors are typically responsive to a touch by a body part, such as a finger or a conductive stylus specifically designed for capacitive sensors. Such touch sensors can possess limitations arising from the mechanisms used for tactile input and/or from the related methods of manufacture.

### SUMMARY

Aspects of the present disclosure include tactile sensors utilizing soft, deformable conductive material disposed on one or more electrodes disposed on a substrate such as a rigid substrate, which produce altered conductivity in response to applied forces, as well as related methods of fabrication.

One general aspect of the present disclosure includes a tactile sensor utilizing soft, deformable conductive material disposed on one or more electrodes disposed on a substrate. The tactile sensor can include: an array of electrodes disposed on a substrate; a deformable conductive layer disposed on the array of electrodes; one or more conductive elements disposed on the deformable conductive layer; a deformable insulative layer disposed on the one or more conductive elements; and an integrated circuit (IC) connected to the array of electrodes and configured to detect a change in resistance between two or more of the electrodes in response to a deformation of the deformable conductive layer, where the IC is configured to produce an output signal indicative of the deformation of the deformable conductive layer. Other embodiments of this aspect include corresponding computer systems, apparatus, and computer programs recorded on one or more computer storage devices, each configured to perform the actions of or related to the sensor, e.g., measuring applied force(s).

Implementations may include one or more of the following features. The tactile sensor may include a rigid substrate. The substrate may include a printed circuit board (PCB). The one or more conductive elements may include an array of conductive elements. The one or more conductive elements may include one or more temperature dependent resistors. The one or more conductive elements may include one or more direction-sensitive cells, where each direction-sensitive cell is configured to produce an output signal indicative of a deformation of the deformable conductive layer in one or more of three directions. The directions may include three orthogonal directions. Each direction-sensitive conductive cell may include three electrode-trace groups, each configured to produce an output signal mainly indicative of an applied force in one of the three directions. Each electrode-trace group may include a temperature dependent resistor. The deformable conductive layer may have a plurality of regions and the one or more conductive elements may include an array of conductive elements having conductive elements in each region; a conductivity of the conductive elements in each region may differ from region to region. The deformable conductive layer may have a conductivity that changes in response to changes in density (e.g., compression).

The IC may be configured to produce an output signal indicative of the deformation of the deformable insulative layer. The output signal may be indicative of a location associated with an applied force applied to the deformable insulative layer. The output signal may be indicative of a direction associated with an applied force applied to the deformable insulative layer. The output signal may be indicative of a magnitude associated with an applied force applied to the deformable insulative layer. The output signal may be indicative of a time associated with an applied force applied to the deformable insulative layer. The output signal may be indicative of a temperature associated with an applied force applied to the deformable insulative layer. The output signal may be indicative of a pressure applied to the deformable insulative layer. The output signal may be indicative of a displacement of the deformable insulative layer. The deformable insulative layer may include thermoplastic polyurethane. The deformable insulative layer may include silicone gel. The IC may include a multiplexer stage configured to select a desired set of the array of electrodes at a given time. Implementations of the described techniques may include hardware, a method or process, or computer software on a computer-accessible medium.

Another general aspect of the present disclosure includes a method of making a tactile sensor. The method can include: providing an array of electrodes disposed on a substrate; providing a deformable conductive layer disposed on the array of electrodes; providing one or more conductive elements disposed on the deformable conductive layer; providing a deformable insulative layer disposed on the one or more conductive elements; and providing an integrated circuit (IC) connected to the array of electrodes and configured to detect a change in resistance between two or more of the electrodes in response to a deformation of the deformable conductive layer, where the IC is configured to produce an output signal indicative of the deformation of the deformable conductive layer and/or a corresponding deformation of the deformable insulative layer. Other embodiments of this aspect may include use of corresponding computer systems, apparatus, and computer programs recorded on one or more computer storage devices.

Implementations may include one or more of the following features. The substrate may include a rigid substrate. The substrate may include a printed circuit board (PCB). The one or more conductive elements may include an array of conductive elements. The one or more conductive elements may include one or more temperature dependent resistors. The one or more conductive elements may include one or more direction-sensitive cells, where each direction-sensitive cell is configured to produce an output signal indicative of a deformation of the deformable conductive layer in one or more of three directions. The directions may include three orthogonal directions. Each direction-sensitive conductive cell may include three electrode-trace groups, each electrode-trace group being configured to produce an output signal mainly indicative of an applied force in one of the three directions. Each electrode-trace group may include a temperature dependent resistor.

The deformable conductive layer may have a plurality of regions and where the one or more conductive elements may include an array of conductive elements having conductive elements in each region, and where a conductivity of the conductive elements in each region differs from region to region. The deformable conductive layer may have a conductivity that changes in response to compression. The IC can be configured to produce an output signal indicative of the deformation of the deformable insulative layer. The output signal may be indicative of a physical parameter associated with an applied force applied to the deformable insulative layer. The deformable insulative layer may include thermoplastic polyurethane. The deformable insulative layer may include silicone gel. Implementations of the described techniques may include use of hardware, a method or process, or computer software on a computer-accessible medium.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The manner and process of making and using the disclosed examples and embodiments of the present disclose may be appreciated by reference to the figures of the accompanying drawings. In the figures like reference characters refer to like components, parts, elements, or steps/actions; however, similar components, parts, elements, and steps/actions may be referenced by different reference characters in different figures. It should be appreciated that the components and structures illustrated in the figures are not necessarily to scale, emphasis instead being placed upon illustrating the principles of the concepts described herein. Furthermore, examples and embodiments are illustrated by way of example and not limitation in the figures, in which:

FIG. 1A-1C show an example tactile sensor, in accordance with an embodiment of the present disclosure.

FIG. 2 shows an example layout of electrodes and metal traces for a 3D sensing tactile “taxel,” in accordance with an embodiment of the present disclosure;

FIGS. 3A-3B show top and side views, respectively, of an example tactile sensor, in accordance with the present disclosure;

FIGS. 4A-4C show side views of an example finite element method model (FEMM) of a tactile sensor in accordance with the present disclosure as modeled subject to perpendicular loading conditions;

FIGS. 5A-5C show side views of an example FEMM of a tactile sensor in accordance with the present disclosure as modeled subject to parallel loading conditions;

FIG. 6 is a block diagram of an example sensor system in accordance with the present disclosure;

FIG. 7 is a diagram showing steps in an example method of making a tactile sensor, in accordance with the present disclosure; and

FIG. 8 is a schematic diagram of an example computer system that can perform all or at least a portion of methods, algorithms, and processing, in accordance with the present disclosure.

### DETAILED DESCRIPTION

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

For many applications, it may be advantageous or required for robots to possess a sense of or feedback mechanism for touch. Such a sense or feedback mechanism can allow or facilitate, e.g., the handling of delicate objects and/or evaluating compliance, friction, or texture, etc., of objects. Aspects of the present disclosure provide touch sensitivity. In some embodiments, one or more such tactile sensors can be used in grippers (gripping mechanisms) used for robots. In some embodiments, such a tactile sensor can be used to evaluate the haptic properties of an item, e.g., product or good.

Aspects of the present disclosure are directed to and include systems, structures, circuits, and methods providing tactile sensors utilizing conductive deformable material(s), e.g., in one or more layers positioned between conductive traces and electrodes. The configurations produce altered conductivity in response to applied forces. The deformation of the deformable layer(s) can be detected by the sensors and used to determine or correlate with physical phenomena/on associated with the applied force(s), e.g., pressure, location, deflection (displacement), applied force, direction of applied force, duration (time) of applied force and/or temperature, etc.

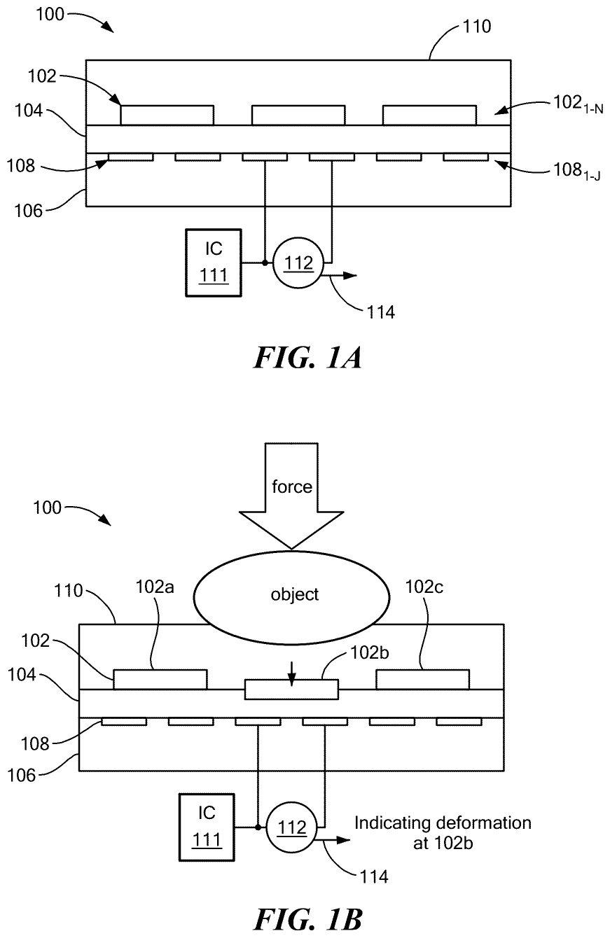

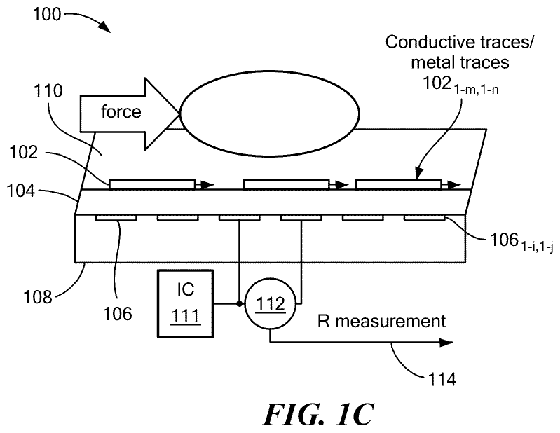

FIGS. 1A-1C show an example tactile sensor system (a.k.a., sensor) 100, in accordance with an embodiment of the present disclosure. Tactile sensor 100 includes a plurality of conductive elements 102, shown as elements 102_{1-N}, e.g., conductive traces, temperature dependent resistors, or other components, disposed on conductive soft material 104, e.g., arranged as a layer. In some embodiments, the conductive elements 102 may form a two-dimensional (2D) array, e.g., as shown in FIG. 1C by the 2D indices for the array of conductive elements. The conductive soft material can be disposed on a substrate 106. An array 108 of conductive electrodes, as shown by elements 108_{1-J}, may be disposed on the substrate 106. In some embodiments, the conductive electrodes 108 may form a two-dimensional (2D) array, e.g., as shown in FIG. 1C by the 2D indices for the array of conductive electrodes. Substrate 106 can be or include a rigid substrate (e.g., printed circuit board, leadframe, ceramic, glass, or other) in some embodiments; in some embodiments substrate 106 may be or include a flexible or semi-rigid substrate. Any suitable material may be used for the layer of conductive soft material 104 and/or layer of insulative deformable material 110, e.g., polyimide, benzocyclobutene (BCB), silicone gel, thermoplastic polyurethane, etc.

In some embodiments, the total thickness of the soft layers (e.g., layer 104+layer 110) can be between about 0.5 mm and about 10 mm; other dimensions may be used in other embodiments of the present disclosure. In some embodiments, the soft layers 104, 110 can be made of thermoplastic polyurethane, silicone, or other suitable materials. In some embodiments, the soft layers can have different electrical properties (e.g., conductive, insulating, or other). The conductive soft layer(s) exhibit a change in electrical conductivity when a force is applied to it/them. The conductivity of the soft layer(s) is preferably significantly lower (e.g., by a factor 1E-3 to 1E-9) than the conductivity of typical metals used in printed circuit boards like copper, aluminum, gold, or others. The soft layers can have different mechanical properties (e.g., elasticity, yield strength, or other). The soft layers can have different thermal conductivity. In some embodiments, the upper surface of the soft layers can be flat or have a certain structure. In some embodiments, conductive traces can be embedded in or in between the soft layers and, in some embodiments, such conductive traces can be or include temperature dependent resistors, resistors sensitive to magnetic field, or other electrical components.

The electrical resistance between different electrodes can be measured, e.g., by an integrated circuit (IC) 111, which is shown as having made a resistance (conductivity) measurement 114. Such an integrated circuit (IC) 111 can be positioned at various locations, e.g., embedded into the rigid substrate, attached to the underside of the rigid substrate, attached to the top side of the rigid substrate, or connected to the rigid substrate by a cable or a flexible substrate, etc. The IC 111 can have a multiplexer stage to make contact to a certain set of the multitude of electrodes at a given time.

The electrical resistances (or, conversely, the electrical conductivities) between different electrodes situated close to each other can be combined in formulas or algorithms to separate the effect of different physical quantities (pressure, forces in different directions, temperature, magnetic field, or others) into individual results correlated predominantly to one of the physical quantities in a certain region (e.g., one or more taxels or electrode-trace groups) of the sensor. The spatial distribution of these results can be used in a different set of formulas or algorithms to identify certain properties like shapes, off-center touch, or others. The time evolution of these results can be used in a different set of formulas or algorithms to identify certain events like slipping, sticking, puncturing, vibration, or others.

In some embodiments, the integrated circuit can have a low power mode that measures the resistance of a subset of the electrodes with a low resolution and/or a low bandwidth. The integrated circuit can have a wake-up function reacting to when a change of resistance is detected in the low power mode, in some embodiments. The integrated circuit (e.g., IC 111) can supply information to a superior control unit via a suitable bus, e.g., CAN, LIN, I2C, SPI, Ethernet, and/or other suitable bus(es).

The electrical resistance between different electrodes can depend on (i) pressure applied to the top of the soft layers, and/or (ii) forces applied in different directions perpendicular or parallel to the surface of the soft layers. The electrical resistance between different electrodes can depend on (i) temperature applied to the surface of the soft layers and/or (ii) other physical quantities like for instance magnetic field present at the surface of or within the soft layers. Electrodes can be arranged in pairs with one conductive trace or other electrical component embedded in the soft layer above the pair of electrodes. Pairs of electrodes with an associated conductive trace can be arranged in triples (which may be referred to as a “taxel”) designed to react differently to forces perpendicular and parallel to the surface of the soft layer and along substantially orthogonal directions. In some embodiments, a temperature dependent resistor can be added to the taxel to enable temperature measurements and compensation of temperature dependent changes of conductivity of the conductive soft layer.

The monitoring circuit/circuitry (e.g., in IC 111) can detect the change in electric conductivity for determining one or more physical conditions or parameters associated with an applied force, e.g., a magnitude, direction, time (duration) and/or location of or associated with the applied force and produce an output signal indicative of the change of conductivity, as explained in further detail below.

FIG. 1B shows reaction of sensor 100 to an applied perpendicular force, i.e., a force applied perpendicular or normal to the surface of the sensor. As shown, an object is in contact with sensor surface. A force is applied through object perpendicular to surface leads to reversible deformation of soft layers. A conductive soft layer between electrodes and traces is compressed, therefore conductivity increases. As a result, electrical resistance between electrodes is reduced. The IC measures the change in resistance and correlates the measurement to an applied force.

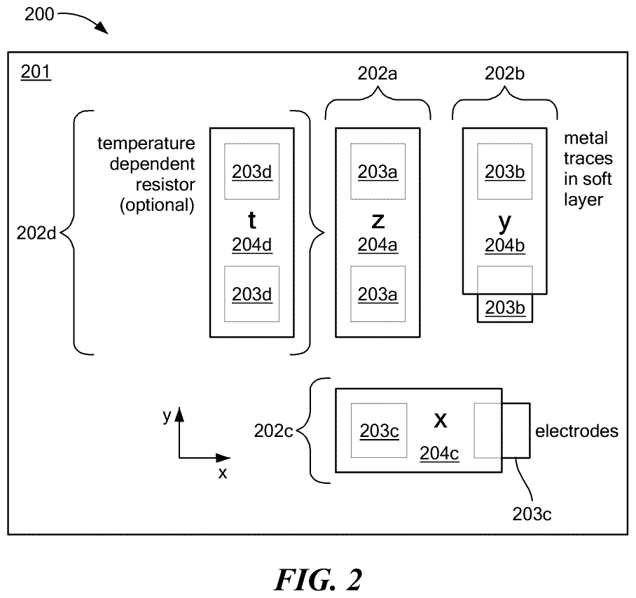

FIG. 1C shows reaction of sensor 100 to an applied parallel force (parallel to sensor surface). As shown, an object is in contact with sensor surface. A force is shown applied through object parallel to surface. This leads to reversible deformation of soft layers. As shown, the metal traces are displaced relative to electrodes, therefore the conduction path through the conductive soft layer is modified. Electrical resistance between electrodes varies under loading conditions (e.g., application of force(s) during grasping of a robotic gripper employing sensor 100) given a suitable layout of electrodes and traces, e.g., as shown in FIGS. 2, 3A-3B, 4A-4C, and 5A-5C, and described in further detail below.

FIG. 2 shows an example layout of electrodes and metal traces for a 3D sensing tactile cell (a.k.a., “taxel”) 200, in accordance with an embodiment of the present disclosure. The tactile cell includes a soft layer 201, three electrode-trace groupings 202a-202c including three pairs of electrodes 203a-203c and metal traces 204a-204c (“electrode-trace” groups) disposed on a substrate (not shown). Soft layer 201 includes conductive compliant material and can be disposed between the pairs of electrodes 203a-203c and metal traces 204a-204c. In some embodiments, a second layer of soft material (e.g., non-conductive) may be disposed on (covering) traces 204a-204c on soft layer 201. The layout of electrodes and metal traces can be used by the cell 200 to discriminate forces in three dimensions (3D), e.g., along x, y, z axes.

The pairs of electrodes 203a-203c can be used to resolve forces applied to cell 300 in 3D. For example, for perpendicular (along the z axis) forces, all resistances change. Lateral forces along the x axis mainly produce changes in resistance measured between electrodes 203c. Similarly, lateral forces along the y axis mainly produce changes in resistance measured between electrodes 203b.

As shown, in some embodiments cell 200 can include an optional electrode-trace grouping 202d having a temperature dependent resistor (TDR) 204d so that cell 200 can compensate for temperature induced changes in conductivity of the soft layer 201. For embodiments using TDRs, the resistance and temperature coefficient of the TDRs are preferably chosen carefully in relation to conductivity of conductive soft layer and metal traces to enable reasonably precise temperature reading.

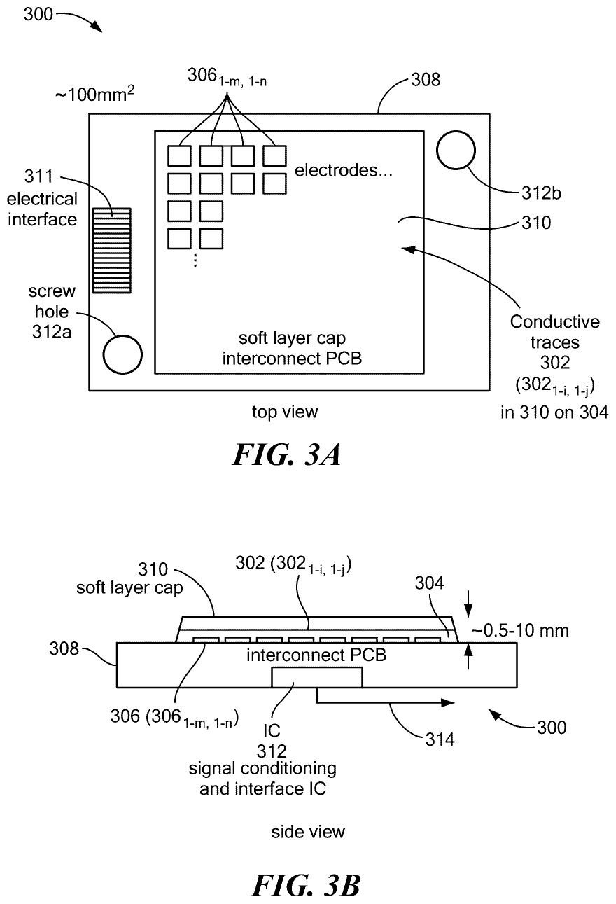

FIGS. 3A-3B show top and side views, respectively, of an example tactile sensor 300, in accordance with the present disclosure. Sensor 300 includes a plurality (array) of conductive traces 302 on conductive soft layer 304, which is disposed over a plurality (array) of electrodes 306 on substrate 308. An insulative soft layer 310, shown as a cap, is disposed over the conductive traces 302 and conductive soft layer 304.

Sensor 300 can implement/have the following functionalities: stand-by mode: watches a set of electrodes (taxels) in parallel with low energy consumption; wake up on initial touch or if asked to; full operation: scans all electrodes; gets force readings in x, y, z for each pixel (taxel); can include one or more algorithms for slipping recognition; “puncture/prick” recognition, e.g., force overshoot on single pixel (taxel); shape recognition; off-center recognition (unsafe gripping); and/or “softness” recognition.

Any suitable bus may be used for sensor 300. Examples include, but are not limited to, the following: I2C, SPI, CAN, e.g., CAN-FD, USB 2.0, USB 3.0, Ethernet 10/100, Ethernet 1000, Ethernet 10GE, or the like. Any suitable electrical interface(s) can be used for sensor 300. Examples includes, but are not limited to, the following: solder pads, connectors, ball grid arrays (BGAs), etc. Any suitable mechanical fixation or fasteners may be used for sensor 300. Examples include, but are not limited to, the following: screws, snap-lock connections, dowels, rivets, etc.

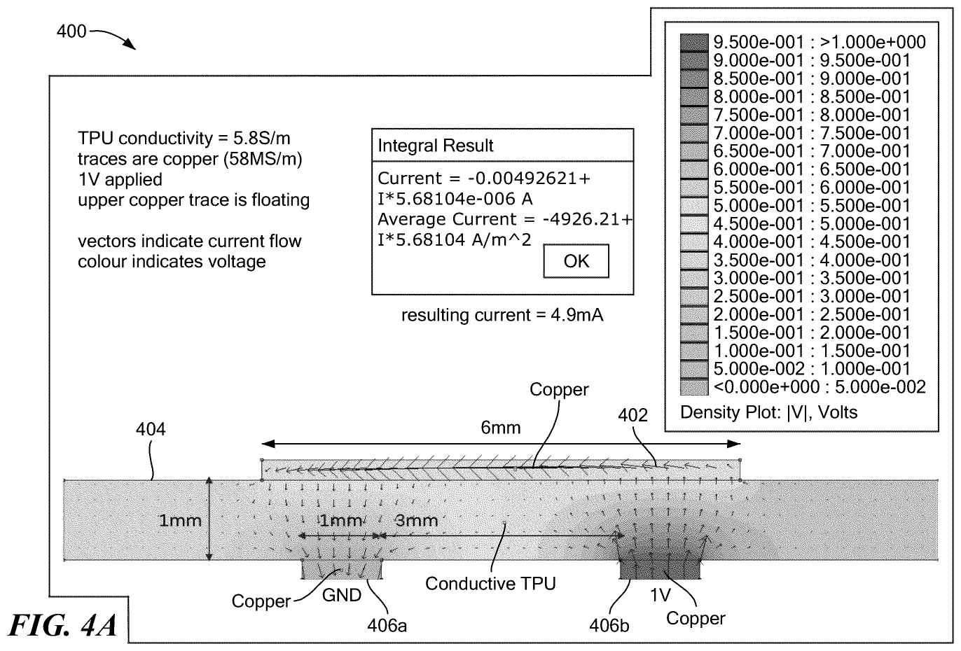

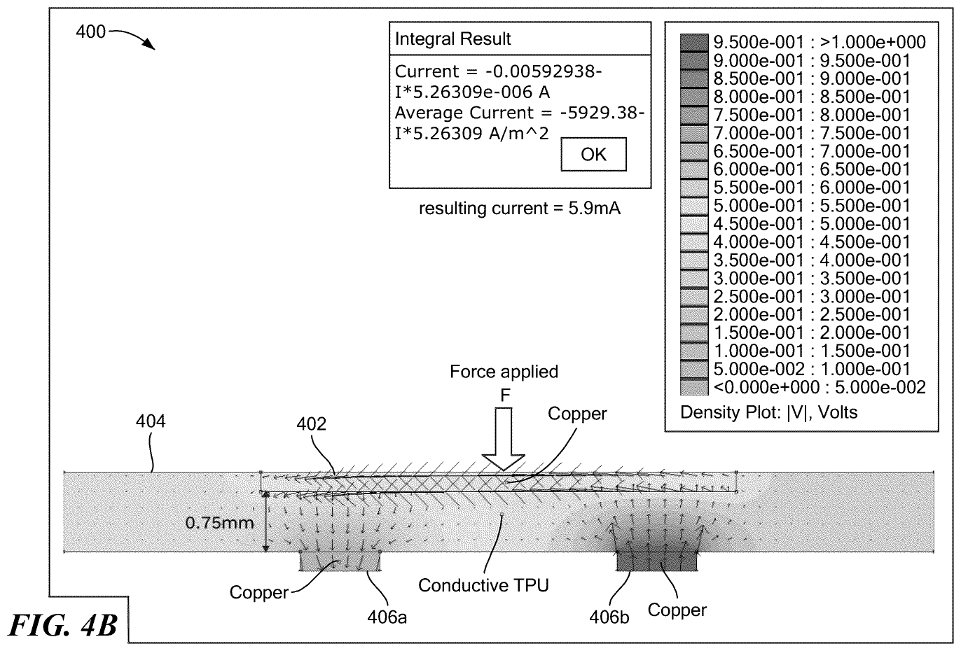

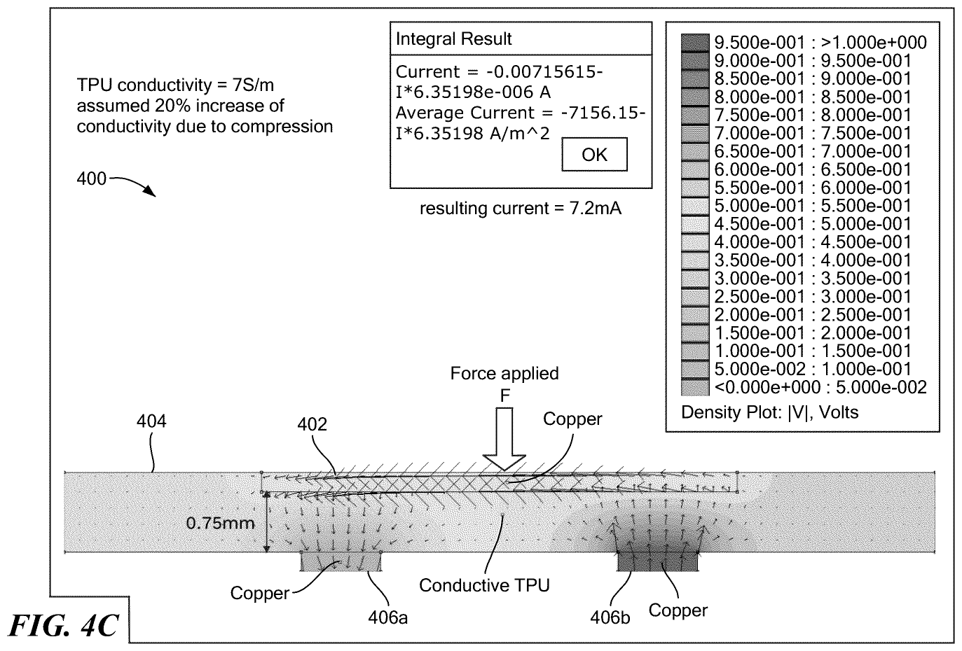

FIGS. 4A-4C show side views of a finite-element-method model (FEMM) of an example tactile sensor 400 in accordance with the present disclosure subject to perpendicular loading conditions. Sensor 400 is shown including a conductive trace 402, a layer of soft conductive material 404, and first and second electrodes 406a-b. The soft conductive material 404 selected for the FEMM was thermoplastic polyurethane (TPU); other suitable materials may of course be utilized within the scope of the present disclosure. The dimensions of the sensor components are indicated (in mm).

As shown in FIG. 4A, without any external loading (application of force), the current through the electrodes was shown to be 4.9 milliamps.

As shown in FIG. 4B, application of the indicated perpendicular force at the indicated position (normal to the upper surface of conductive trace 402), deforms the layer of soft conductive material 404, pushing the conductive trace 402 closer to electrodes 406a-b. Under this loading condition, the resulting current through the electrodes was shown to be 5.9 milliamps.

As shown in FIG. 4C, Under this loading condition, the resulting current through the electrodes was shown to be 7.2 milliamps. In some embodiments, the material of the soft conductive layer 404 changes its conductivity due to changes in density due to the applied force(s) (e.g., compression or expansion). These density-based changes in conductivity can enhance the change of current (in response to applied forces) observed by the sensor 400.

In summary, for the indicated perpendicular loading conditions of FIGS. 4A-4C, the FEMM simulations show that a conductive, compressible material can be used to build a resistive force or touch sensor that reacts to a perpendicular force if the conductive, compressible material even changes its conductivity due to compression, the effect may be enhanced.

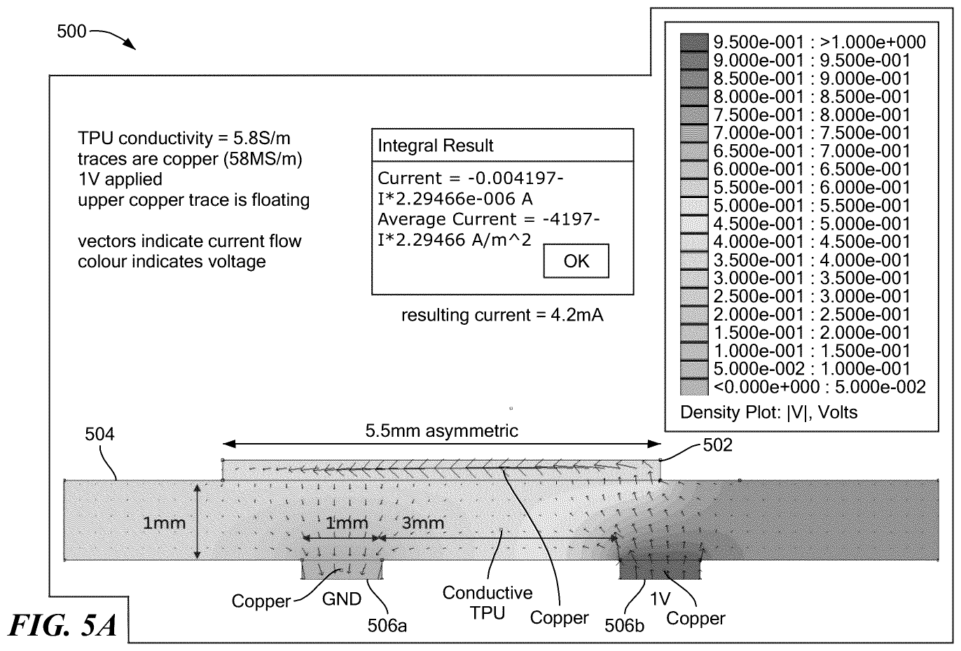

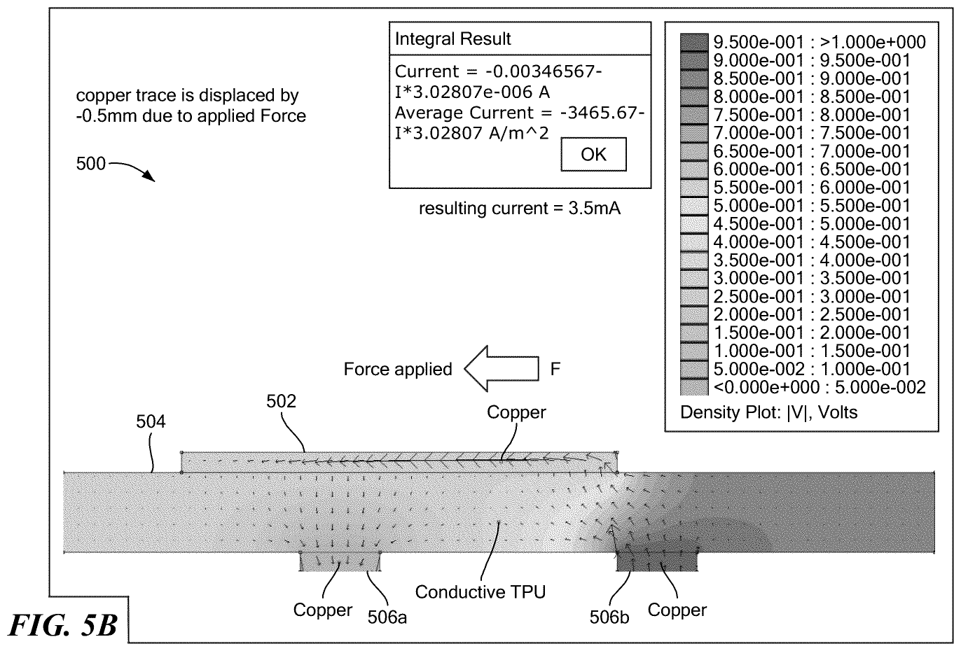

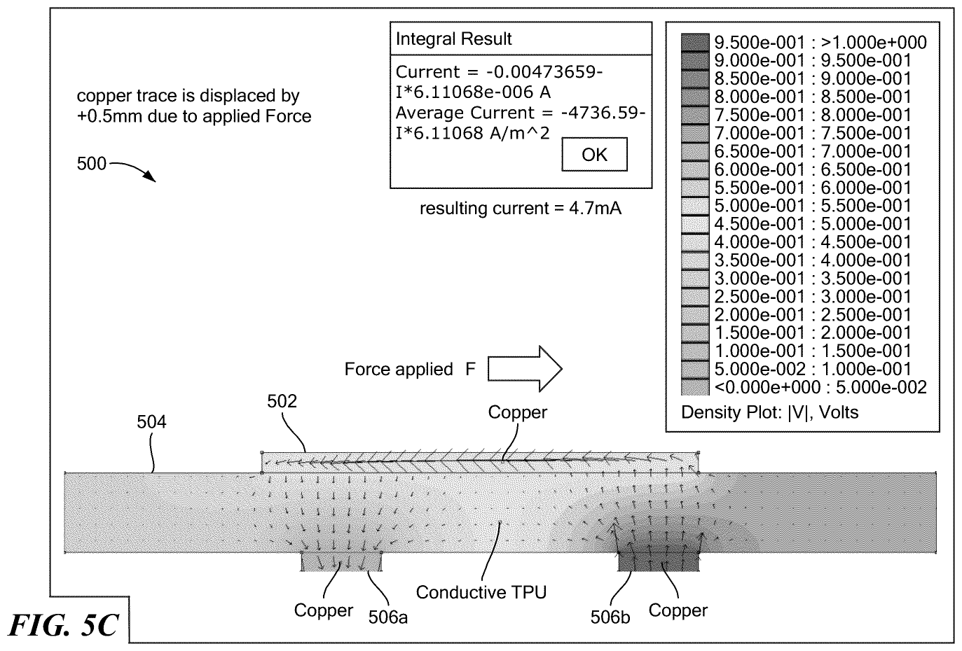

FIGS. 5A-5C show side views of an example FEMM of a tactile sensor 500 in accordance with the present disclosure subject to parallel loading conditions. Sensor 500 is shown including a conductive trace 502, a layer of soft conductive material 504, and first and second electrodes 506a-b. The soft conductive material 504 selected for the FEMM was thermoplastic polyurethane (TPU); other suitable materials may of course be utilized within the scope of the present disclosure. The dimensions of the sensor components are indicated (in mm). As shown, conductive trace 502 is positioned asymmetrically with respect to electrodes 506a and 506b; in some embodiments, this feature can be beneficial for detecting parallel forces.

As shown in FIG. 5A, without any external loading (application of force), the current through the electrodes was shown to be 4.2 milliamps.

As shown in FIG. 5B, application of the indicated parallel force at the indicated position (to the left and parallel to the upper surface of conductive trace 502), deforms the layer of soft conductive material 504, pushing the conductive trace 502 to the left. Under this loading condition, the resulting current through the electrodes was shown to be 3.5 milliamps.

As shown in FIG. 5C, application of the indicated parallel force at the indicated position (parallel to the upper surface of conductive trace 502) to the right (i.e., opposite to the loading shown in FIG. 5B), deforms the layer of soft conductive material 504, pushing the conductive trace 402 to the right. Under this loading condition, the resulting current through the electrodes was shown to be 4.7 milliamps.

In summary, for the indicated parallel loading conditions the FEMM simulations show that a conductive, compressible material can be used to build a resistive force or touch sensor that reacts to a force parallel to the surface. An asymmetric upper conductor trace can be used to facilitate measurement of parallel forces (e.g., forces applied parallel to the surface layer of the sensor). For such sensor configurations, perpendicular forces will also result in signals but could be evaluated against a symmetric trace (e.g., as shown in FIGS. 4A-4C).

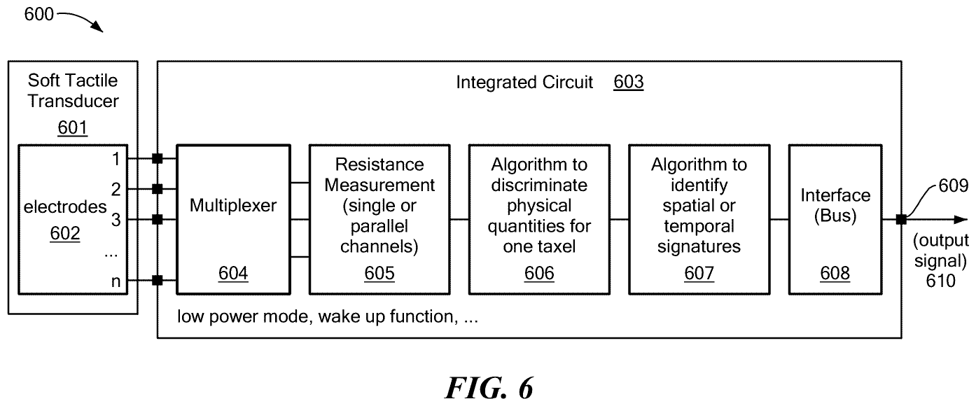

FIG. 6 is a block diagram of an example sensor system 600, in accordance with the present disclosure. Sensor system 600 is shown including a soft tactile transducer 601 having an array of electrodes 602. In some embodiments, transducer 601 and array 602 may have structures similar to elements 102-110 shown and described for FIGS. 1A-1C. Sensor system 600 also includes an integrated circuit (IC) 603 connected to array 602.

IC 603 includes multiplexor 604, which is configured to measure changes in resistance (or conductivity)-shown at 605-of array 602 in operation, e.g., under various operational conditions such as application(s) of force to transducer 601. In some embodiments, resistance measurement 605 can be made based on single or parallel channels of outputs (electrical signals) from array 602. Multiplexor 604 can control the selection of single or parallel channels (or other configurations) of signals from array 602.

IC 603 can process the signals using one or more algorithms to discriminate physical quantities for one taxel, as indicated at 606. IC 603 can process the signals using one or more algorithms to identify one or more spatial and/or temporal signatures, as indicated at 607. IC 603 can include an interface (bus) 608 for interfacing, e.g., at output terminal 609, with components outside of IC 603. IC 603 can produce one or more output signals 610, which can include information/indications regarding applied force(s) applied to sensor system 600 at soft tactile transducer 601. System 600 may include other and/or additional components/algorithms/code in some embodiments.

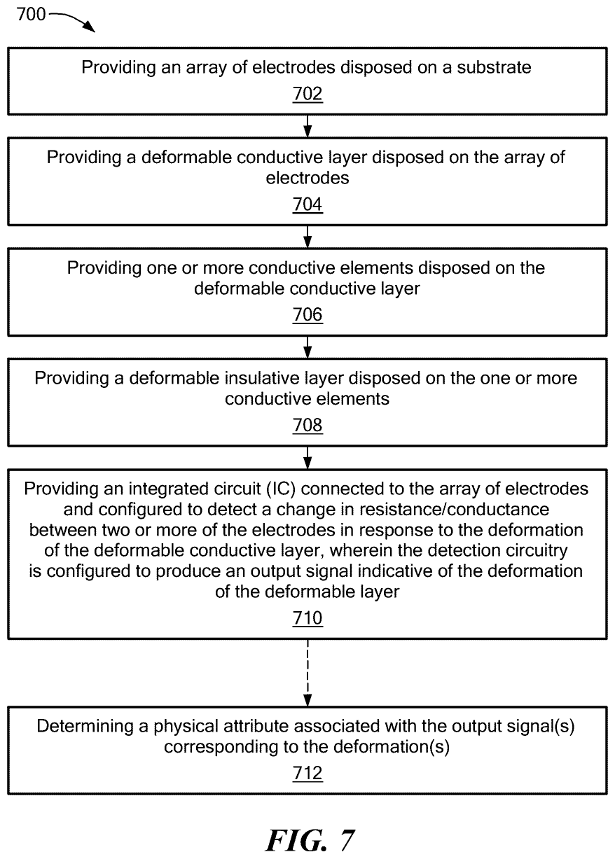

FIG. 7 is a diagram showing steps in an example method 700 of making tactile sensors in accordance with the present disclosure. Method 700 can include providing an array of electrodes disposed on a substrate, as described at 702. In some embodiments, the substrate may be a PCB. A deformable conductive layer can be disposed on the array of electrodes, as described at 704. One or more conductive elements can be disposed on the deformable conductive layer, as described at 706. A deformable insulative layer can be provided that is disposed on the one or more conductive elements, as described at 708. An IC can be provided that is connected to the array of electrodes and configured to detect a change in resistance/conductance between two or more of the electrodes in response to the deformation of the deformable conductive layer, wherein the detection circuitry is configured to produce an output signal indicative of the deformation of the deformable layer, as described at 710. One or more physical attributes/quantities/parameters associated with the deformation can be determined based on the output signal(s), as described at 712.

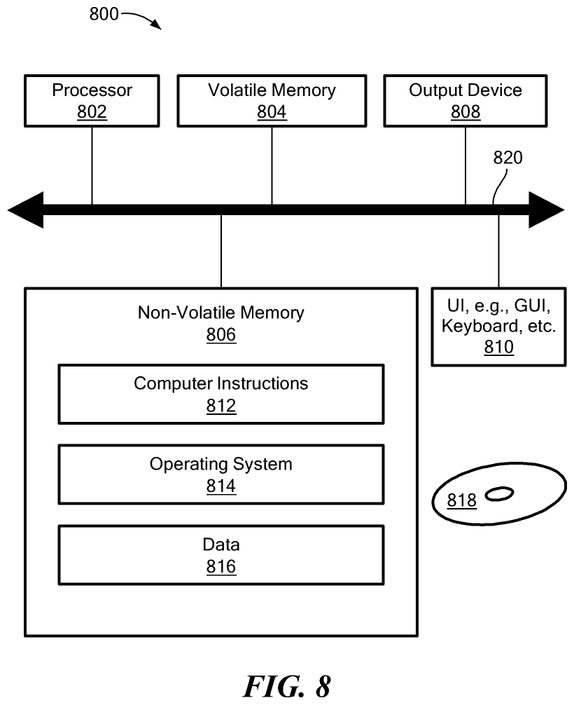

FIG. 8 is a schematic diagram of an example computer system 800 that can perform all or at least a portion of the processing, e.g., steps in the algorithms and methods, including determination of magnitude, direction, temperature, time (duration) and/or location of or associated with an applied force and/or pressure, as described herein. The computer system 800 can include a processor 802, a volatile memory 804, a non-volatile memory 806 (e.g., hard disk), an output device 808 and a user input or interface (UI) 810, e.g., graphical user interface (GUI), a mouse, a keyboard, a display, and/or any common user interface, etc. The non-volatile memory (non-transitory storage medium) 806 stores computer instructions 812 (a.k.a., machine-readable instructions or computer-readable instructions) such as software (computer program product), an operating system 814 and data 816. In one example, the computer instructions 812 are executed by the processor 802 out of (from) volatile memory 804. In one embodiment, an article/apparatus 818 (e.g., a storage device or medium such as a hard disk, an optical disc, magnetic storage tape, optical storage tape, flash drive, etc.) includes or stores the non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), and optionally at least one input device, and one or more output devices. Program code may be applied to data entered using an input device or input connection (e.g., port or bus) to perform processing and to generate output information.

The system 800 can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as special purpose logic circuitry, e.g., an FPGA (field programmable gate array) and/or an ASIC (application-specific integrated circuit).

Accordingly, embodiments of the inventive subject matter can afford various benefits relative to prior art techniques. For example, embodiments and examples of the present disclosure can provide accurate and readily fabricated touch sensing functionality for integrated circuits (ICs), semiconductor (IC) die, and/or packages including IC die, e.g., transformer based galvanically isolated gate drivers or other high voltage circuits. Moreover, embodiments and examples of the present disclosure can provide tactile sensors having higher spatial resolutions compared to prior art tactile sensors. Embodiments can also provide lower manufacturing cost and/or general complexity is much lower compared to prior art tactile sensors.

Various embodiments of the concepts, systems, devices, structures, and techniques sought to be protected are described above with reference to the related drawings. Alternative embodiments can be devised without departing from the scope of the concepts, systems, devices, structures, and techniques described. For example, while substrates have been described herein in the context of PCBs, any other suitable substrates may be used within the scope of the present disclosure.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive inclusion. For example, an apparatus, a method, a composition, a mixture, or an article, which includes a list of elements is not necessarily limited to only those elements but can include other elements not expressly listed or inherent to such apparatus, method, composition, mixture, or article.

Additionally, the term “exemplary” means “serving as an example, instance, or illustration. Any embodiment or design described as “exemplary” is not necessarily to be construed as preferred or advantageous over other embodiments or designs. The terms “one or more” and “at least one” indicate any integer number greater than or equal to one, i.e., one, two, three, four, etc.; though, where context admits, those terms may indicate fractional values. The term “plurality” indicates any integer or fractional number greater than one. The term “connection” can include an indirect “connection” and a direct “connection.”

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed but are used merely as labels to distinguish one claim element having a certain name from another element having a same name (but for use of the ordinal term) to distinguish the claim elements.

The terms “approximately” and “about” may be used to mean within ±20% of a target (or nominal) value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within +5% of one another in some embodiments, and yet within ±2% of one another in some embodiments.

The term “substantially” may be used to refer to values that are within ±20% of a comparative measure in some embodiments, within +10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A tactile sensor comprising:
an array of electrodes disposed on a substrate;
a deformable conductive layer disposed on the array of electrodes;
one or more conductive elements disposed on the deformable conductive layer;
a deformable insulative layer disposed on the one or more conductive elements; and
an integrated circuit (IC) connected to the array of electrodes and configured to detect a change in resistance between two or more of the electrodes in response to a deformation of the deformable conductive layer, wherein the IC is configured to produce an output signal indicative of the deformation of the deformable conductive layer.

2. The tactile sensor of claim 1, wherein the substrate comprises a rigid substrate.

3. The tactile sensor of claim 2, wherein the substrate comprises a printed circuit board (PCB).

4. The tactile sensor of claim 1, wherein the one or more conductive elements comprises an array of conductive elements.

5. The tactile sensor of claim 1, wherein the one or more conductive elements comprises one or more temperature dependent resistors.

6. The tactile sensor of claim 1, wherein the one or more conductive elements comprise one or more direction-sensitive cells, wherein each direction-sensitive cell is configured to produce an output signal indicative of a deformation of the deformable conductive layer in one or more of three directions.

7. The tactile sensor of claim 6, wherein the directions comprise three orthogonal directions.

8. The tactile sensor of claim 6, wherein each direction-sensitive conductive cell comprises three electrode-trace groups, each configured to produce an output signal mainly indicative of an applied force in one of the three directions.

9. The tactile sensor of claim 8, wherein each electrode-trace group further comprises a temperature dependent resistor.

10. The tactile sensor of claim 1, wherein the deformable conductive layer has a plurality of regions and wherein the one or more conductive elements comprises an array of conductive elements having conductive elements in each region, and wherein a conductivity of the conductive elements in each region differs from region to region.

11. The tactile sensor of claim 1, wherein the deformable conductive layer has a conductivity that changes in response to compression.

12. The tactile sensor of claim 1, wherein the IC is configured to produce an output signal indicative of the deformation of the deformable insulative layer.

13. The tactile sensor of claim 12, wherein the output signal is indicative of a location associated with an applied force applied to the deformable insulative layer.

14. The tactile sensor of claim 12, wherein the output signal is indicative of a direction associated with an applied force applied to the deformable insulative layer.

15. The tactile sensor of claim 12, wherein the output signal is indicative of a magnitude associated with an applied force applied to the deformable insulative layer.

16. The tactile sensor of claim 12, wherein the output signal is indicative of a time associated with an applied force applied to the deformable insulative layer.

17. The tactile sensor of claim 12, wherein the output signal is indicative of a temperature associated with an applied force applied to the deformable insulative layer.

18. The tactile sensor of claim 12, wherein the output signal is indicative of a pressure applied to the deformable insulative layer.

19. The tactile sensor of claim 12, wherein the output signal is indicative of a displacement of the deformable insulative layer.

20. The tactile sensor of claim 1, wherein the deformable insulative layer comprises thermoplastic polyurethane.

21. The tactile sensor of claim 1, wherein the deformable insulative layer comprises silicone gel.

22. The tactile sensor claim 1, wherein the IC includes a multiplexer stage configured to select a desired set of the array of electrodes at a given time.

23. A method of making a tactile sensor, the method comprising:
providing an array of electrodes disposed on a substrate;
providing a deformable conductive layer disposed on the array of electrodes;
providing one or more conductive elements disposed on the deformable conductive layer;
providing a deformable insulative layer disposed on the one or more conductive elements; and
providing an integrated circuit (IC) connected to the array of electrodes and configured to detect a change in resistance between two or more of the electrodes in response to a deformation of the deformable conductive layer, wherein the IC is configured to produce an output signal indicative of the deformation of the deformable conductive layer and/or a corresponding deformation of the deformable insulative layer.

24. The method of claim 23, wherein the substrate comprises a rigid substrate.

25. The method of claim 23, wherein the substrate comprises a printed circuit board (PCB).

26. The method of claim 23, wherein the one or more conductive elements comprises an array of conductive elements.

27. The method of claim 23, wherein the one or more conductive elements comprises one or more temperature dependent resistors.

28. The method of claim 23, wherein the one or more conductive elements comprise one or more direction-sensitive cells, wherein each direction-sensitive cell is configured to produce an output signal indicative of a deformation of the deformable conductive layer in one or more of three directions.

29. The method of claim 28, wherein the directions comprise three orthogonal directions.

30. The method of claim 28, wherein each direction-sensitive conductive cell comprises three electrode-trace groups, each electrode-trace group being configured to produce an output signal mainly indicative of an applied force in one of the three directions.

31. The method of claim 30, wherein each electrode-trace group further comprises a temperature dependent resistor.

32. The method of claim 23, wherein the deformable conductive layer has a plurality of regions and wherein the one or more conductive elements comprises an array of conductive elements having conductive elements in each region, and wherein a conductivity of the conductive elements in each region differs from region to region.

33. The method of claim 23, wherein the deformable conductive layer has a conductivity that changes in response to compression.

34. The method of claim 23, wherein the IC is configured to produce an output signal indicative of the deformation of the deformable insulative layer.

35. The method of claim 34, wherein the output signal is indicative of a physical parameter associated with an applied force applied to the deformable insulative layer.

36. The method of claim 23, wherein the deformable insulative layer comprises thermoplastic polyurethane.

37. The method of claim 23, wherein the deformable insulative layer comprises silicone gel.
